(19) United States
(12) Patent Application Publication
(10) Pub. No.: US 2025/0363003 A1
(43) Pub. Date: Nov. 27, 2025

(54) TAG WAY-HALTING

(71) Applicant: Arm Limited, Cambridge (GB)

(72) Inventors: Edward Martin McCombs, JR., Austin, TX (US); Andrew David Tune, Dronfield (GB); Sean James Salisbury, Dendron (GB); Akshay Kumar, New Delhi (IN)

(21) Appl. No.: 18/673,614

(22) Filed: May 24, 2024

(51) Int. Cl. G06F 11/10

(52) U.S. Cl. CPC G06F 11/1068; G06F 11/1016

(57) ABSTRACT

A memory subsystem can include a preamble tag memory and one or more prologue tag memories for one or more ways. The preamble tag memory includes hit circuitry. The preamble tag memory stores a set of bits from a tag portion of a plurality of addresses stored at the memory subsystem. The preamble memory hit circuitry performs a comparison of preamble bits of a received address and the stored set of bits from the tag portion in the preamble tag memory. Each prologue tag memory includes hit circuitry. The prologue tag memories store a remaining set of bits from the tag portion and memory data information of the plurality of addresses. The prologue memory hit circuitry performs a comparison of prologue bits of the received address and the stored remaining set of bits from the tag portion in that prologue tag memory.

### BACKGROUND

Cache memory and other memory subsystems can be located relatively close to a processor to provide fast access of frequently used data to the processor. Random Access Memory (RAM), and specifically Static Random Access Memory (SRAM), is typically the type of memory used for these memory subsystems. SRAM is generally configured as an array, or matrix of memory units that are individually addressable.

Memory can be set-associative and organized by index and way. A cacheline refers to the data corresponding to a memory address. A set refers to a limited number of places in the memory where a cacheline can reside (e.g., if associativity is equal to 1, the memory is considered to be “direct mapped”). Each associativity corresponds to a “way”. For example, an associativity of 2 corresponds to two ways, an associativity of 4 corresponds to four ways, and an associativity of 16 corresponds to 16 ways. The index indicates which set a cacheline is stored or is to be stored into and is computed from the address. A tag refers to part of the address that is stored in the tag RAM and identifies, in conjunction with the index, the memory address that the cacheline corresponds with.

To find whether a memory address is in the cache memory or other memory subsystem, a lookup operation can be performed in the tag RAMs. As part of the lookup operation, a portion of an incoming address (e.g., the portion providing the tag function) is compared to the stored tags in the tag RAMs. A “hit” occurs when the incoming address (e.g., the portion providing the tag function) matches a stored tag in a way and the stored tag is considered valid (e.g., as per appropriate state bits(s)). In a typical n-way set-associative cache, data belonging to an address will be in 0 or 1 of n places. Based on the hit of the incoming tag portion with a tag in the tag RAM, the appropriate data RAM can be accessed. For a typical way-halting cache there is an attempt to reduce the number of bits of the tags that are accessed in each way. Thus, if there is any partial mismatch during the lookup (a “miss”), accesses to that way are halted, saving power by not accessing the full tag address lookup.

Accessing memory, such as RAM, utilizes large amounts of energy when multiple ways are accessed all at once using an incoming address to find a matching address that may be in one way of the memory. A process that can locate the desired tag while accessing a minimal number of ways has the potential to save a substantial amount of energy.

### BRIEF SUMMARY

A method and system for tag way halting are provided that can be optimized for energy savings and latency.

A system in which tag way halting can be implemented includes a memory subsystem including a preamble tag memory and one or more prologue tag memories for one or more ways. The preamble tag memory includes a preamble memory array, a preamble memory control circuit, a preamble memory wordline driver, a preamble memory input/output circuitry, and preamble memory hit circuitry. The preamble tag memory stores a first set of bits from a tag portion of a plurality of addresses stored at the memory subsystem. The preamble memory hit circuitry performs a comparison of preamble bits of a received address and the stored first set of bits from the tag portion in the preamble tag memory. The one or more prologue tag memories each includes a prologue memory array, a prologue memory control circuit, a prologue memory wordline driver, a prologue memory input/output circuitry, and a prologue memory hit circuitry. The one or more prologue tag memories store a second set of bits from the tag portion and memory data information of the plurality of addresses. The prologue memory hit circuitry performs a comparison of prologue bits of the received address and the stored second set of bits from the tag portion in that prologue tag memory.

A method of performing tag way halting can include receiving, at a memory subsystem, an address for lookup; determining, using preamble memory hit circuitry of a preamble tag memory of the memory subsystem, a partial hit of the received address for a tag in a way; and for each partial hit of the received address, accessing a prologue tag memory of the memory subsystem associated with the way and determining, using prologue memory hit circuitry of the prologue tag memory, a hit of the received address for the tag in the way. The preamble tag memory stores a first set of bits from a tag portion of a plurality of addresses stored at the memory subsystem, wherein the preamble memory hit circuitry performs a comparison of preamble bits of the received address and the stored first set of bits from the tag portion in the preamble tag memory. The prologue tag memory stores a second set of bits from the tag portion of at least some of the plurality of addresses stored at the memory subsystem and corresponding memory data information, wherein the prologue memory hit circuitry performs a comparison of prologue bits of the received address and the stored second set of bits from the tag portion in the prologue tag memory.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a simplistic representation of a lookup operation for a memory access in an n-way cache.

FIG. 1B shows a simplistic representation of a proposed two-phase access utilizing a memory architecture as described herein.

FIG. 1C illustrates a method of performing tag way halting with a two-phase access.

FIG. 2A illustrates a representational diagram of memory circuitry that can be used in a first phase of tag way-halting as described herein.

FIG. 2B illustrates a representational diagram of memory circuitry that can be used in a second phase of tag way-halting as described herein.

FIG. 3 shows an example implementation of hit circuitry for a memory circuitry.

FIGS. 4A and 4B illustrate example memory subsystems that omit (FIG. 4A) and include (FIG. 4B) the memory architecture described herein.

FIG. 5A illustrates an example of data that may be stored in a memory array of a way halting cache as described herein.

FIG. 5B illustrates another example of data that may be stored in a memory array of a way halting cache as described herein.

### DETAILED DESCRIPTION

A method and system for performing tag way-halting are presented. As described herein, tag way halting can be performed as part of a two-phase access, where a tag lookup occurs in two parts where a first part of the tag lookup is used to filter accesses to ways containing bits of the tag for the second part of the tag lookup by inhibiting access to memory of the ways that mismatch. The first part of the tag lookup uses a first set of bits of the tag and can be referred to as “preamble bits” or “preamble”. The second part of the tag lookup uses a second set of bits of the tag and can be referred to as “prologue bits” or “prologue”.

Current way halting techniques and configurations can suffer from high energy consumption and area overhead due to duplication of efforts across many ways (e.g., as part of additional circuitry and parallel operations) and can suffer delay penalties due to routing hit signals across a chip to different banks and memories.

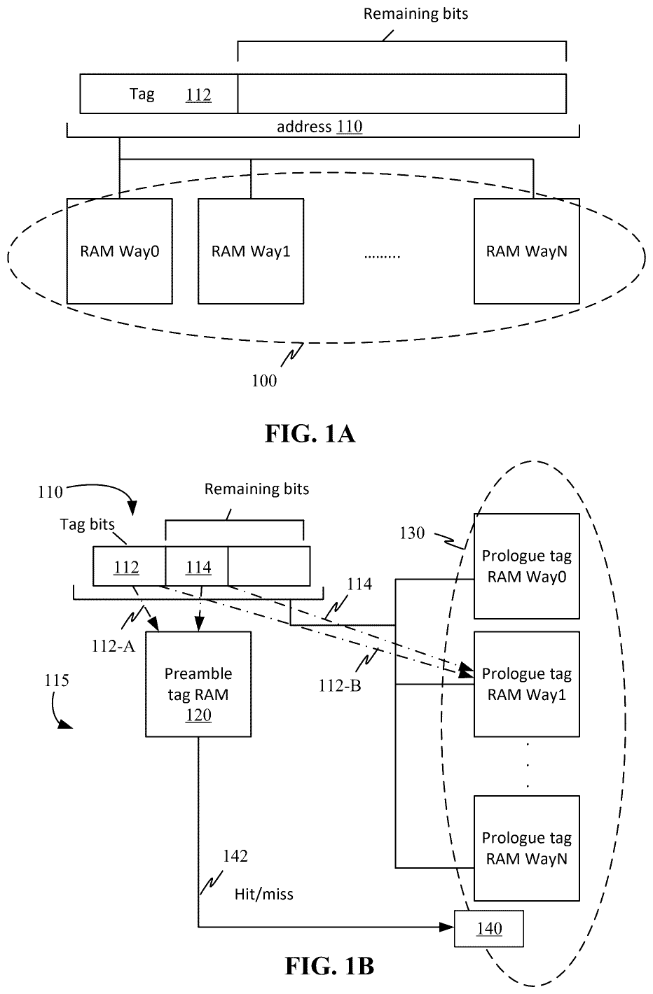

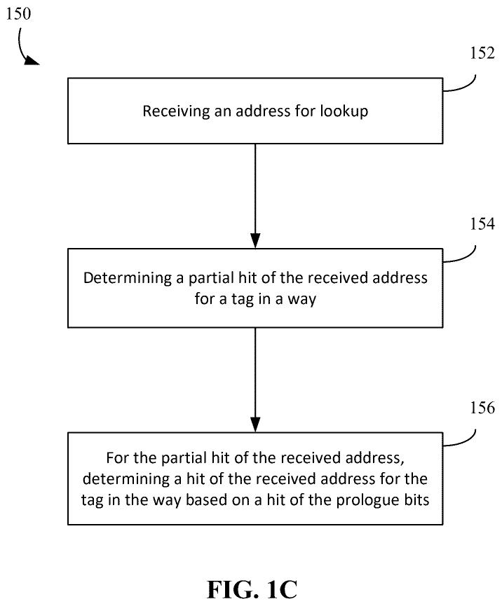

In addition, the power consumption due to parallel accesses of multiple memories can be an issue. Current way halting techniques are frequency limiting by looking up the preamble and prologue in the same RAM access. This creates a long cycletime and makes it unusable in modern designs. For example, FIG. 1A shows a simplistic representation of a lookup operation for a memory access in an n-way cache.

Referring to FIG. 1A, during a lookup operation for a memory access in an n-way cache 100, an address 110 comes into the memory subsystem and goes out to all n ways (e.g., RAM Way0, RAM Way1, . . . , RAM WayN) of the n-way cache 100. Each RAM (e.g., RAM Way0, RAM Way1, . . . , RAM WayN) includes a memory array, a wordline driver, and input/output circuitry. It should be understood that while n RAMs are shown for n ways for illustrative purposes, more than one way may be combined in a same RAM. For example, two or more ways may be combined into one RAM.

Accessing all n ways to compare tags (e.g., tag 112 of address 110) requires the precharging and access operations for the memories storing all n ways and therefore consumes a significant amount of power. In addition, bits read from and written to these tag memories are sent to and received from all across the chip when performing various conventional tag way halting approaches, which can contribute to delay penalties. To address these potential energy inefficiencies and latencies, a technique involving sequential accesses while combining certain operations for tag way halting is presented.

FIG. 1B shows a simplistic representation of a proposed two-phase access utilizing a memory architecture as described herein. FIG. 1C illustrates a method of performing tag way halting with a two-phase access.

Referring to FIG. 1B, an n-way cache 115 of a proposed memory architecture can include a preamble tag memory (preamble tag RAM 120) and one or more prologue tag memories/RAMs 130 (where n is an integer equal to or greater than 1). A two-phase access is enabled by using the preamble tag RAM 120 to control access to the prologue tag memories 130 for the n ways.

First, a hit or miss of a first set of bits (e.g., preamble 112-A) of the tag portion 112 with respect to each way of a plurality of ways is determined at the preamble tag RAM 120 using the preamble 112-A and an index portion 114 of the address 110 for lookup. Then, for each hit of the first set of bits, a corresponding way with stored prologue bits of the tags and remaining memory data information of the addresses accessed and a hit or miss of the prologue 112-B of the tag portion 112 with respect to that corresponding way is determined using the prologue 112-B and the index portion 114 of the address 110 for lookup (e.g., with appropriate prologue tag memory accessed as enabled by selection logic 140 coupled to the prologue tag memories 130 that enables access to each of the prologue tag memories 130 under control of a hit or miss signal(s) 142 output from the preamble tag RAM).

In that manner, only the ways that correspond to the partial hit from the preamble tag RAM 120 are accessed in the prologue tag RAM and the prologue 112-B of the address 110 is used to determine a fully complete, combined hit or miss for the address 110.

Accordingly, referring to FIG. 1B and FIG. 1C, a method 150 of performing tag way halting includes receiving (152) an address 110 for lookup; determining (154) a partial hit of the received address 110 for a tag in a way; and for the partial hit of the received address, determining (156) a hit of the received address based on a hit of the prologue bits (112-B) of the received address 110 for the tag in the way. In some cases, the first set of bits contains between 3-7 bits of the tag portion of the address for lookup. In a specific implementation, the first set of bits contains 4 bits. In some cases, a portion of the least significant bits of the tag bits are selected as the first set of bits.

Method 150 can be implemented in a system having a cache or other memory subsystem (e.g., n-way cache 115) including a preamble tag memory (e.g., preamble tag RAM 120) and one or more prologue tag memories for one or more ways (e.g., prologue tag memory 130).

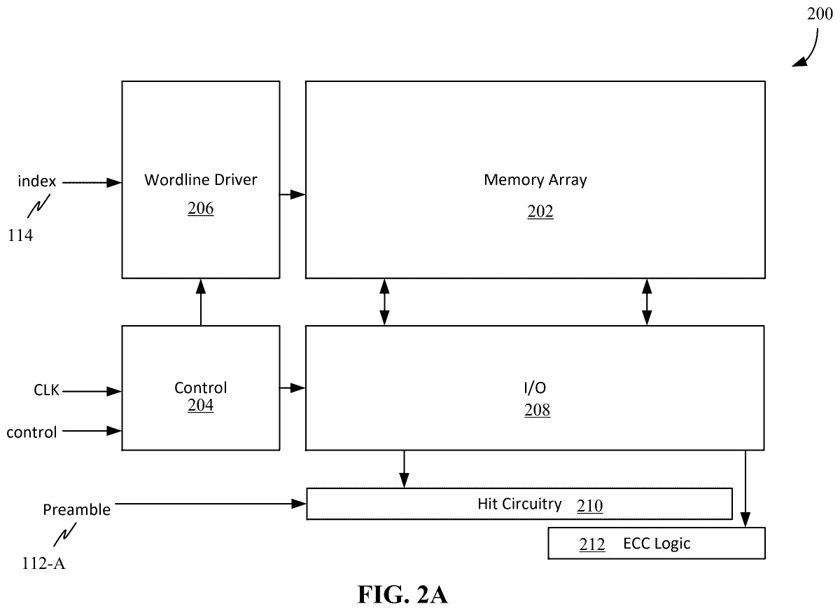

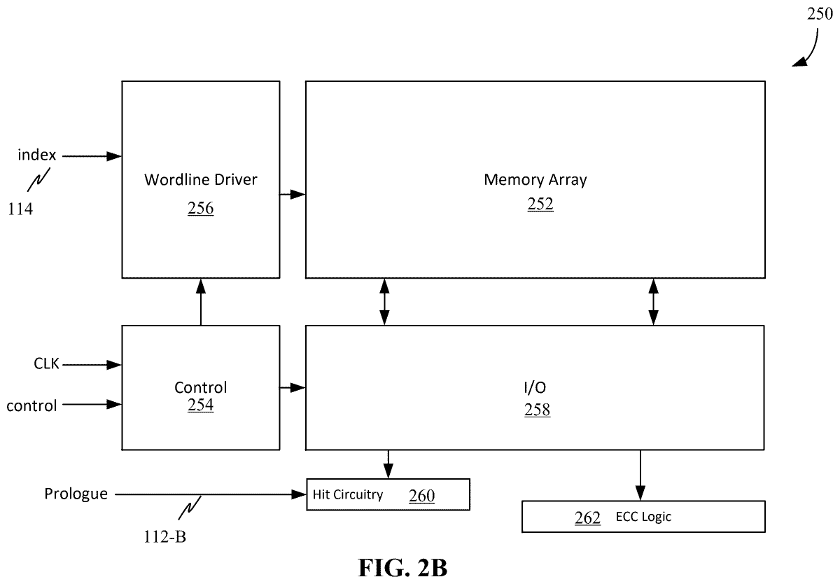

An example implementation of preamble tag RAM 120 is shown in FIG. 2A. For example, the preamble tag memory (e.g., preamble tag RAM 120) includes: a preamble memory array, a preamble memory control circuit, a preamble memory wordline driver, a preamble memory input/output circuitry, and a preamble memory hit circuitry. An example implementation of a prologue tag memory 130 is shown in FIG. 2B. The one or more prologue tag memories each comprises a prologue memory array, a prologue memory control circuit, a prologue memory wordline driver, a prologue memory input/output circuitry, and a prologue memory hit circuitry.

Accordingly, determining (156) the partial hit of the received address for a tag in a way can use preamble memory hit circuitry of a preamble tag memory, wherein the preamble tag memory stores a first set of bits of a tag portion of a plurality of addresses stored at the memory subsystem, wherein the preamble memory hit circuitry performs a comparison of preamble bits of the received address and the stored first set of bits of the tag portion in the preamble tag memory. In addition, for each partial hit of the received address, method 150 includes accessing a prologue tag memory associated with the way. Here, the determining (158) the hit of the received address for the tag in the way can use the prologue memory hit circuitry of the prologue tag memory, wherein the prologue tag memory stores a second set of bits of the tag portion of at least some of the plurality of addresses stored at the memory subsystem and corresponding memory data information, wherein the prologue memory hit circuitry performs a comparison of prologue bits of the received address and the stored second set of bits of the tag portion in the prologue tag memory.

The preamble tag memory (e.g., preamble tag RAM 120) and the one or more prologue tag memories (e.g., prologue tag memory 130) can each further include part of an error correction code circuitry. In cases where the error correction code circuitry is included in the memory, a method of performing tag way halting can include performing a partial error correction code operation in the preamble tag memory when (e.g., same cycle as) comparing the preamble bits stored in the preamble tag memory to preamble bits of a received address for lookup using the hit circuitry; and performing a partial error correction code operation in the prologue tag memory storing remaining bits for the way(s) corresponding to the partial hit from the preamble tag memory when comparing the prologue bits in the prologue tag memory to the prologue bits from the received address using the hit circuitry (e.g., performing a partial error correction code operation in the prologue tag memory for the stored second set of bits in a row being compared by the prologue memory hit circuitry and for the memory data information in the row). The part of the error correction code circuitry in the n-way cache can be used to minimize the bits read out from the preamble tag memory and the n ways (e.g., of the prologue tag memories) when performing error correction.

As mentioned above, while n prologue RAMs are shown for n ways 130 for illustrative purposes, more than one way may be combined in a same RAM. In addition, in some cases, more than one pre-RAM is provided in order to be able to store the preambles of all the ways. As an illustrative example, the n-way cache 115 can further include a second preamble tag memory and one or more corresponding prologue tag memories for additional one or more ways of the cache 115.

FIG. 2A illustrates a representational diagram of a memory circuitry that can be used in a first phase of tag way-halting as described herein. Referring to FIG. 2A, memory circuitry 200 includes a memory array 202, a control circuit 204, wordline driver 206, input/output circuitry 208, and hit circuitry 210. Memory circuitry 200 can further include part of an error correction code circuitry (ECC logic 212).

The memory array 202 is structured in an array of bitcells with rows accessed by wordlines and columns accessed by bitlines. Each bitcell refers to the memory element storing a single bit of information. In certain implementations, memory array 202 is static random-access memory (SRAM). The control circuit 204 provides control signals for operations of the memory circuitry 200. The wordline driver 206 receives an address and turns on a wordline indicated by the address in response to receiving a signal from the control circuit 204. The input/output circuitry 208 contains the read circuitry and write circuitry that utilize bitlines to read and write data out of and into the memory array 202.

The hit circuitry 210 supports the determination of a hit/miss of the tag bits within the memory circuitry 200. In particular, the hit circuitry 210 of the preamble tag memory performs a comparison of the preamble of a received address 110 and the stored first set of bits of the tag portion in the preamble tag memory that is read out from the index. In some cases, the hit circuitry 210 includes comparators that are coupled to receive the preamble bits of an arriving address and the preamble bits of each way stored in a row of the memory array 202 (e.g., by being coupled to sense amplifiers of the columns of the memory array).

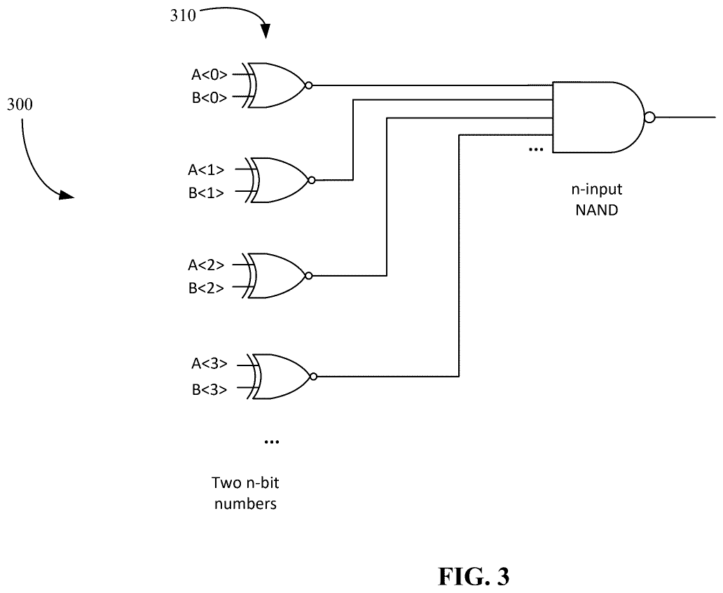

In some implementations, the hit circuitry 210 includes XNOR gates for performing a comparison between two 1-bit inputs and an AND or NAND gate that receives the outputs of the XNOR gates corresponding to the bits of a preamble of a way. The AND or NAND gate provides an output indicative of whether all preamble bits of a tag match (and thereby indicate a partial hit of the tag). In some cases, hit circuitry 210 can be implemented as shown in FIG. 3.

For example, the hit circuitry 210 can include a set of XNOR gates coupled to receive the preamble bits of the received address and the stored first set of bits of the tag portion of a corresponding way in the preamble tag memory; and a NAND gate that receives outputs of the set of XNOR gates to output a signal indicating a hit or miss of preamble bits of that corresponding way. Each way stored in the memory array 202 can have a corresponding set of XNOR gates. The hit circuitry 210 can further include additional circuitry such as a latch or flip flop.

The ECC logic 212 supports certain parts of error correction processes within the memory circuitry 200.

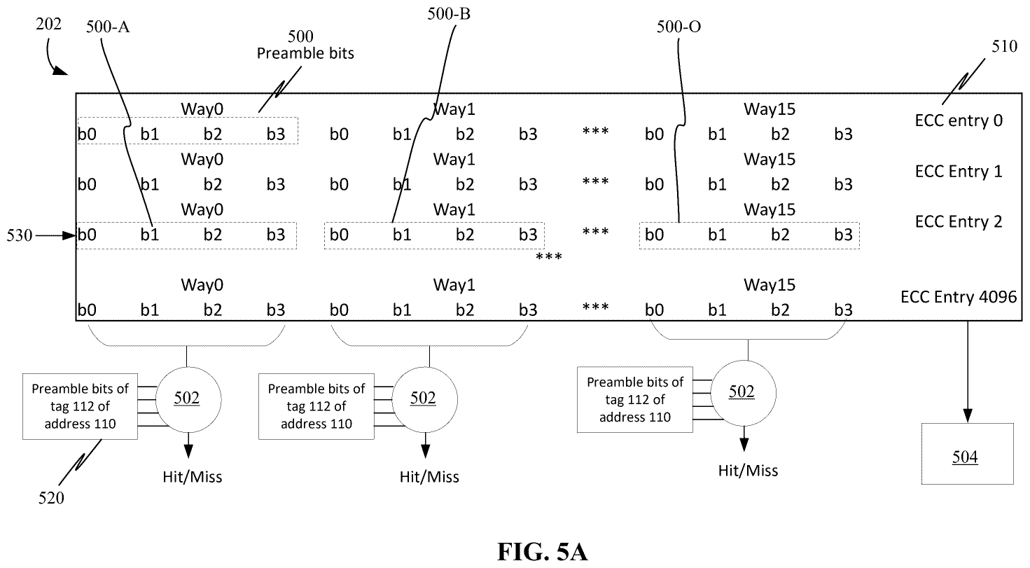

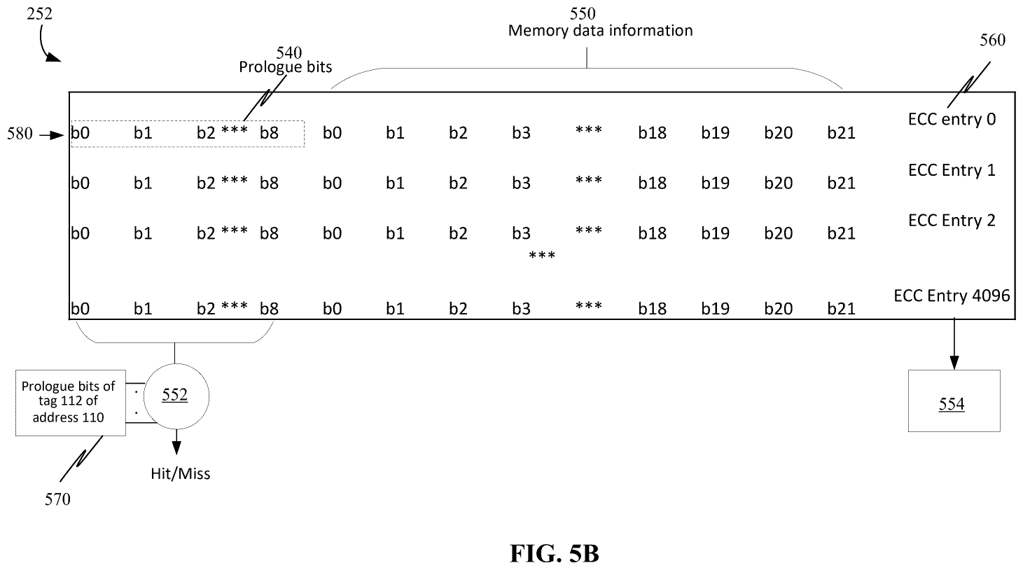

Accordingly, in the architecture of the n-way cache 115 described with respect to FIG. 1B, memory array 202 stores a first set of tag bits of each of a plurality of the ways (e.g., the preamble portion). In some cases, the first set of tag bits of all of the n ways are able to be stored in the memory array 202. In cases where the first set of tag bits of all of the n ways are not able to be stored in the memory array 202 (e.g., due to there being more bits than available space), additional memory circuitry 200 (e.g., additional preamble tag RAM 120) can be provided for the preamble portions. FIG. 5A illustrates example data that may be stored in a memory array 202 implementing the preamble tag RAM 120. The first set of bits (e.g., the preamble 112-A) from the tag portion 112 of an arriving address 110 is used by the hit circuitry 210 for determining a hit or miss of the first set of bits with respect to each way of the plurality of the ways covered by memory circuitry 200. Index bits 114 of the arriving address 110 are used to select the appropriate wordline by wordline driver 206.

The ECC logic 212 uses the ECC bits stored in the memory array 202 to carry out a partial operation of ECC operations (e.g., at least a portion of a detection operation). ECC bits are used to determine the integrity of the data (e.g., whether a value has flipped such as due to radiation, etc.) and can be used to perform error correction. In the preamble tag RAM 120, the ECC bits stored in the memory array 202 cover the preamble bits of all the ways that are stored in a row of the memory array 202.

Advantageously, by incorporating the hit circuitry 210 in memory 200, determining a hit or miss of the first set of bits with respect to each way of a plurality of ways can be performed as part of a read operation of the memory 200. By incorporating ECC logic 212 in memory 200, a partial error correction code operation can also be performed as part of the read operation.

FIG. 2B illustrates a representational diagram of a memory circuitry that can be used in a second phase of tag way-halting as described herein. Referring to FIG. 2B, memory circuitry 250 includes a memory array 252, a control circuit 254, wordline driver 256, input/output circuitry 258, and hit circuitry 260. Memory circuitry 250 can further include part of an error correction code circuitry (ECC logic 262). Memory array 252, control circuit 254, wordline driver 256, and input/output circuitry 258 can be implemented such as described with respect to memory array 202, control circuit 204, wordline driver 206, and input/output circuitry 208 as described with respect to FIG. 2A.

Similar to that described with respect to hit circuitry 210 of FIG. 2A, hit circuitry 260 supports the determination of a hit/miss of the tag bits within the memory circuitry 250. In particular, the hit circuitry 260 of the one or more prologue tag memories performs a comparison of the prologue of the received address 110 and the stored prologue bits (e.g., second set of bits) of the tag portions stored in that prologue tag memory. In some cases, the hit circuitry 260 includes comparators that are coupled to receive the prologue bits of an arriving address and the prologue bits of each way stored in a row of the memory array 252 (e.g., by being coupled to sense amplifiers of the columns of the memory array).

In some implementations, the hit circuitry 260 includes XNOR gates for performing a comparison between two 1-bit inputs and an AND or NAND gate that receives the outputs of the XNOR gates corresponding to the bits of a prologue of a way. The AND or NAND gate provides an output indicative of whether all prologue bits of a tag match (and thereby indicate a resulting hit of the tag). In some cases, hit circuitry 260 can be implemented as shown in FIG. 3. For example, The hit circuitry 260 of each prologue tag memory can include a set of XNOR gates coupled to receive the prologue bits of the received address and the stored prologue bits of the tag portion of a corresponding way in the prologue tag memory; and a NAND gate that receives outputs of the set of XNOR gates to output a signal indicating a hit or miss of prologue bits of that corresponding way. Each way stored in the memory array 252 can have a corresponding set of XNOR gates. The hit circuitry 260 can further include additional circuitry such as a latch or flip flop.

The ECC logic 262 supports certain parts of error correction processes within the memory circuitry 250.

As mentioned above, for each partial hit of the preamble determined in the first phase, a prologue tag RAM storing a corresponding way is accessed, and determination of a hit or miss is performed using the prologue bits of the address. Therefore, in the architecture of the n-way cache 115 described with respect to FIG. 1B, memory array 252 stores the prologue portion of a tag and other memory data information in the prologue RAM corresponding to that way. FIG. 5B illustrates example data that may be stored in a memory array 252 of a memory storing prologue bits, e.g., of a prologue tag memory 130. Here, the second set of bits (e.g., the prologue bits 112-B) from the tag portion 112 of the arriving address 110 are used by the hit circuitry 260 to determine a hit or miss of the prologue bits. In this way, the prologue bits are only accessed in the second phase when there is a partial hit on the preamble bits. Although not shown, other logic may be carried out on some of the other memory data information in the prologue tag RAM. In addition, for a hit in the prologue tag RAM, the other memory data information in the prologue RAM can be read out and used in subsequent phases (e.g., to access the data at the address indicated by the memory data information and/or provide the data).

Similar to that described with respect to FIG. 2A, address bits (“index portion”) from set portion 114 are used to select the appropriate wordline by wordline driver 256. In addition, the ECC logic 262 uses the ECC bits stored in the memory array 252 to carry out a partial operation of ECC operations (e.g., at least a portion of a detection operation). The ECC bits stored in the memory array 252 can correspond to the bits of the address in a row for one way stored in the prologue tag RAM, for the bits of the address of more than one way if more than one way is stored in a row, and/or for an entire row.

Advantageously, by incorporating the hit circuitry 260 in memory 250, determining a hit or miss of the prologue bits from the tag portion of the address at a particular way can be performed in a subsequent cycle to the first phase and this subsequent phase can be part of a read operation of the memory 250. By incorporating ECC logic 262 in memory 250, a partial error correction code operation can also be performed in the subsequent cycle to the first phase.

In addition, by using two different tag memories (e.g., one for preambles and one for prologues), it is possible to place a preamble tag RAM closer to control logic than the prologue tag RAM. In addition, by incorporating hit circuitry in the tag memories, it is possible to increase speed and provide further power savings from the interconnecting wires.

FIG. 3 shows an example implementation of hit circuitry for a memory circuitry. Referring to FIG. 3, hit circuitry 300 has a XNOR+NAND combination that includes a set of XNOR gates 310 coupled to receive two n-bit numbers. The two n-bit numbers are the two numbers being compared to determine a hit or miss, for example a part of a tag portion of a received address and a part of a tag portion of an address stored in a memory. The output of each XNOR gate is coupled to an n-input NAND gate 320. The Boolean combination of the XNOR+NAND functions similarly to the equality operator “!=” (not equal to), which returns true if the operands do not have the same value and otherwise returns false. That is, if all bits of the n-bit number stored in the memory match all bits of the n-bit number of the part of the tag portion of the received address, then the output indicates a hit (e.g., in the illustrated case, a “0” indicates a hit) else the output indicates a miss (e.g., in the illustrated case, a “1” indicates a miss.

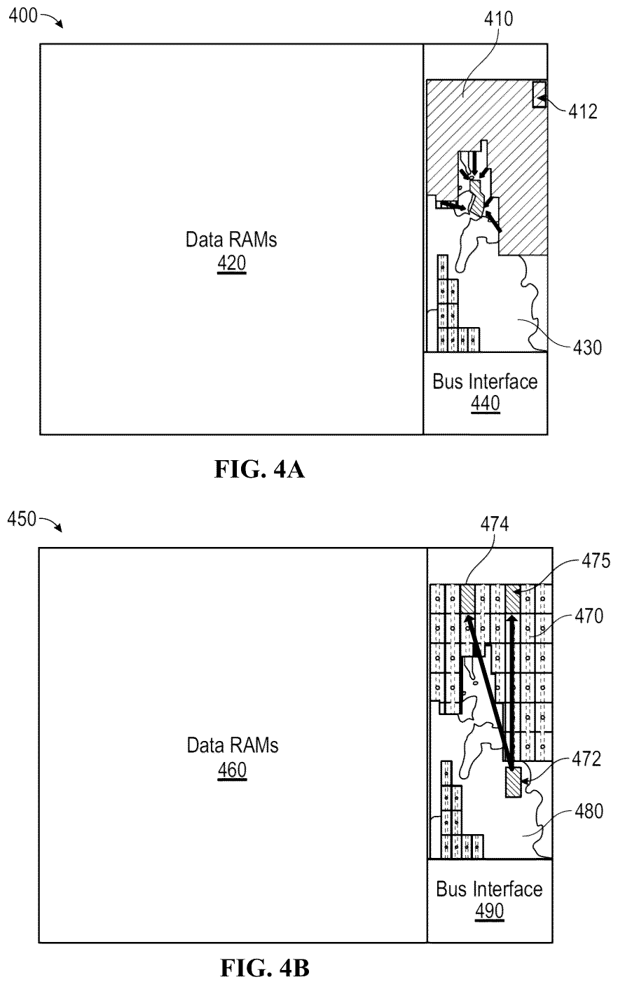

FIGS. 4A and 4B illustrate example memory subsystems that omit (FIG. 4A) and include (FIG. 4B) the memory architecture described herein. Referring to FIG. 4A, memory subsystem 400 includes tag RAMs 410, data RAMs 420, and control logic 430. Data comes into the memory subsystem 400 through a bus interface 440. Without the memory architecture described herein, a tag lookup in the tag RAMs 410 involves accessing all the ways so that every access may require sending signals to the farthest way (e.g., tag RAM 412) over the interconnecting wires, resulting in significant power consumption.

Referring to FIG. 4B, memory subsystem 450 includes data RAMs 460, a set of RAMs for use in lookup (e.g., tag RAMs 470), and control logic 480. Here, tag RAMs 470 are configured according to the memory architecture described herein with at least one preamble tag RAM 472 and a plurality of prologue tag RAMs. As illustrated by the figure, when data comes into the memory subsystem 450 through the bus interface 490 and applied by the control logic 480, a preamble tag RAM 472 is accessed first and only the ways that hit during the first phase are accessed in the second phase. For example, a first prologue tag RAM 474 and a second prologue tag RAM 475 containing prologue bits of the tags of ways that had a partial hit in the first phase are accessed.

As can be seen, in contrast to the memory subsystem 400, by including the described two-phase access memory architecture in a memory subsystem 450, not only is it possible to have instances where a farthest way RAM is not accessed, the preamble tag RAM 462 can be placed closest (or at least at a preferred distance) from the control logic 480.

Accordingly, by incorporating additional logic within the RAM used for a Way Halting Cache, it is possible to minimize the timing delays caused by the slow speed of current memories as compared to the increased operational speed of logic circuitry when having to first read out all of the bits in the RAM before performing logic operations to complete a lookup operation in the Way Halting Cache. Furthermore, by reducing the number of RAMs being accessed, additional power savings can be achieved.

FIG. 5A illustrates an example of data that may be stored in a memory array of a way halting cache as described herein. Referring to FIG. 5A, data within memory array 202 can include the preamble bits 500 from a plurality of ways (and may include the preamble bits from all available ways). In the example, preamble bits of a 16-way cache are shown. Here, four bits of the tag (b0, b1, b2, b3) are stored as the preamble for each way (Way0, Way1, . . . , Way 15) in a row of the memory array 202. In addition, ECC bits 510 are stored, covering the preambles of all sixteen ways. In such a case, 6 ECC bits may be used as an example.

Accordingly, with reference to both FIG. 5A and FIG. 2A, hit circuitry 210 can compare (502) all the preamble bits in the row to the preamble bits 520 from the address 110. For example, for row 530, preamble bits 500-A of Way0, preamble bits 500-B of Way1, all the way to preamble bits 500-O of Way15 are each compared (502) to preamble bits 520 (e.g., of tag 112 of address 110). In addition, the ECC logic 212 can be used to perform a first partial error correction code operation (504) utilizing the ECC bits 510 for that row.

FIG. 5B illustrates another example of data that may be stored in a memory array of a way halting cache as described herein. Referring to FIG. 5B, data within memory array 252 can include the prologue bits 540, memory data information 550, and ECC bits 560 for each row (whether one or more ways are in the RAM) or per way in a row. In the example, 9 prologue bits (based on 4 preamble bits of a 13-bit tag being stored in a preamble tag RAM), 22 bits of the remaining address information, and corresponding ECC bits are stored in each entry. Six ECC bits may be used as an example.

Accordingly, with reference to both FIG. 5B and FIG. 2B, hit circuitry 260 can compare (552) the prologue bits 540 of an entry (e.g., a row 580) to the prologue bits 570 from the address 110. In addition, the ECC logic 262 can be used to perform a first partial error correction code operation (554) utilizing the ECC bits 560 for that entry (e.g., covering the prologue bits and remaining address information).

It should be understood that for the examples shown in FIGS. 5A and 5B, the distribution of tag bits into the preamble and prologue is for illustrative purposes only. Selection of the number of bits to be preamble bits can be based on optimizations for energy consumption and area as some examples. In some cases, the LSBs (least significant bits) of a tag portion of an address are used for the preamble as these are the most likely bits to change in value.

As can be apparent from the example data shown in FIGS. 5A and 5B and with reference to FIG. 1B, a logical model of an address includes a tag portion, a set portion, and a data portion. The tag portion contains the tag bits. When an address arrives at the cache/memory subsystem for lookup against the addresses stored in the cache/memory subsystem, tag bits of the tag portion of the arriving address 110 are used to check against the tag bits of the addresses stored in the preamble tag RAM 120 and, depending on the resulting partial hit(s), against the tag bits of the addresses stored in the prologue tag RAM(s). For an arriving address 110, the set portion 114 includes index bits, which can be used to access appropriate cells in memory (e.g., as an index for wordline/row selection). The data portion of an address can include various information bits. The information bits in the stored data portion can include error correction code (ECC) bits, valid bit (e.g., whether the data is valid/meaningful), and security bits, as some examples. In some current technologies, the tag portion of an address includes 13 bits and the set portion of an address includes 13 bits. The number of bits in the data portion is dependent on the size of the cacheline (and can be considered sub-cacheline address bits).

It should be understood that while specific examples have been made with reference to set-associative caches, the described systems and techniques are applicable to other memory architectures including skewed-associative cache and architectures that are at least partly set-associative.

Certain embodiments of the illustrated methods and circuitry include the following.

Clause 1. A system for performing tag way halting comprising: a memory subsystem including a preamble tag memory and one or more prologue tag memories for one or more ways, wherein the preamble tag memory comprises: a preamble memory array, a preamble memory control circuit, a preamble memory wordline driver, a preamble memory input/output circuitry, and a preamble memory hit circuitry, wherein the preamble tag memory stores a first set of bits from a tag portion of a plurality of addresses stored at the memory subsystem, wherein the preamble memory hit circuitry performs a comparison of preamble bits of a received address and the stored first set of bits from the tag portion in the preamble tag memory, and wherein the one or more prologue tag memories each comprises a prologue memory array, a prologue memory control circuit, a prologue memory wordline driver, a prologue memory input/output circuitry, and a prologue memory hit circuitry, wherein the one or more prologue tag memories store a second set of bits from the tag portion and memory data information of the plurality of addresses, wherein the prologue memory hit circuitry performs a comparison of prologue bits of the received address and the stored second set of bits from the tag portion in that prologue tag memory.

Clause 2. The system of clause 1, wherein the preamble memory hit circuitry comprises: a set of XNOR gates coupled to receive the preamble bits of the received address and the stored first set of bits from the tag portion of a corresponding way in the preamble tag memory; and a NAND gate that receives outputs of the set of XNOR gates to output a signal indicating a hit or miss of preamble bits of that corresponding way.

Clause 3. The system of clause 1 or 2, wherein the prologue memory hit circuitry of each prologue tag memory comprises: a set of XNOR gates coupled to receive the prologue bits of the received address and the stored second set of bits from the tag portion of a corresponding way in the prologue tag memory; and a NAND gate that receives outputs of the set of XNOR gates to output a signal indicating a hit or miss of prologue bits of that corresponding way.

Clause 4. The system of any preceding clause, further comprising selection logic coupled to the one or more prologue tag memories that enables access to each of the one or more ways under control of a hit or miss signal output from the preamble memory hit circuitry of the preamble tag memory.

Clause 5. The system of any preceding clause, wherein the preamble tag memory further stores error correction code bits covering preamble bits of all ways in a row.

Clause 6. The system of clause 5, wherein the preamble tag memory further includes part of an error correction code circuitry.

Clause 7. The system of any preceding clause, wherein each prologue tag memory of the one or more prologue tag memories further stores error correction code bits.

Clause 8. The system of clause 7, wherein each prologue tag memory further includes part of an error correction code circuitry.

Clause 9. The system of any preceding clause, wherein each prologue tag memory of the one or more prologue tag memories is structured for storing the second set of bits and the memory data information of two or more ways.

Clause 10. The system of any preceding clause, wherein the memory subsystem further comprises a second preamble tag memory and one or more corresponding prologue tag memories for additional one or more ways of the memory subsystem.

Clause 11. A method of performing tag way halting, the method comprising: receiving, at a memory subsystem, an address for lookup; determining, using preamble memory hit circuitry of a preamble tag memory of the memory subsystem, a partial hit of the received address for a tag in a way, wherein the preamble tag memory stores a first set of bits from a tag portion of a plurality of addresses stored at the memory subsystem, wherein the preamble memory hit circuitry performs a comparison of preamble bits of the received address and the stored first set of bits from the tag portion in the preamble tag memory; and for each partial hit of the received address, accessing a prologue tag memory of the memory subsystem associated with the way and determining, using prologue memory hit circuitry of the prologue tag memory, a hit of the received address for the tag in the way, wherein the prologue tag memory stores a second set of bits from the tag portion of at least some of the plurality of addresses stored at the memory subsystem and corresponding memory data information, wherein the prologue memory hit circuitry performs a comparison of prologue bits of the received address and the stored second set of bits from the tag portion in the prologue tag memory.

Clause 12. The method of clause 11, wherein the determining the partial hit of the received address for the tag in the way is performed in a first cycle.

Clause 13. The method of clause 12, wherein the first cycle is part of a read operation of the preamble tag memory.

Clause 14. The method of clause 12 or 13, wherein, in the first cycle, the method further comprises performing a partial error correction code operation in the preamble tag memory for the stored set of bits in a row being compared by the preamble memory hit circuitry.

Clause 15. The method of any of clauses 12-14, wherein accessing the prologue tag memory associated with the way and determining the hit of the received address for the tag in the way are performed in a subsequent cycle.

Clause 16. The method of clause 15, wherein the subsequent cycle is part of a read operation of the prologue tag memory.

Clause 17. The method of clause 15 or 16, wherein, in the subsequent cycle, the method further comprises performing a partial error correction code operation in the prologue tag memory for the stored second set of bits in a row being compared by the prologue memory hit circuitry and for the memory data information in the row.

Clause 18. The method of any of clauses 11-17, wherein the preamble bits of the tag portion contains between 3-7 bits.

Clause 19. The method of any of clauses 11-18, wherein the preamble memory hit circuitry comprises: a set of XNOR gates coupled to receive the preamble bits of the received address and the stored first set of bits from the tag portion of a corresponding way in the preamble tag memory; and a NAND gate that receives outputs of the set of XNOR gates to output a signal indicating a hit or miss of preamble bits of that corresponding way.

Clause 20. The method of any of clauses 11-19, wherein the prologue memory hit circuitry of each prologue tag memory comprises: a set of XNOR gates coupled to receive the prologue bits of the received address and the stored second set of bits from the tag portion of a corresponding way in the prologue tag memory; and a NAND gate that receives outputs of the set of XNOR gates to output a signal indicating a hit or miss of prologue bits of that corresponding way.

Although the subject matter has been described in language specific to structural features and/or acts, it is to be understood that the subject matter defined in the appended claims is not necessarily limited to the specific features or acts described above. Rather, the specific features and acts described above are disclosed as examples, implementing the claims and other equivalent features and acts; they are intended to be within the scope of the claims.

What is claimed is:

1. A system for performing tag way halting comprising:
a memory subsystem including a preamble tag memory and one or more prologue tag memories for one or more ways,
wherein the preamble tag memory comprises: a preamble memory array, a preamble memory control circuit, a preamble memory wordline driver, a preamble memory input/output circuitry, and a preamble memory hit circuitry, wherein the preamble tag memory stores a first set of bits from a tag portion of a plurality of addresses stored at the memory subsystem, wherein the preamble memory hit circuitry performs a comparison of preamble bits of a received address and the stored first set of bits from the tag portion in the preamble tag memory, and
wherein the one or more prologue tag memories each comprises a prologue memory array, a prologue memory control circuit, a prologue memory wordline driver, a prologue memory input/output circuitry, and a prologue memory hit circuitry, wherein the one or more prologue tag memories store a second set of bits from the tag portion and memory data information of the plurality of addresses, wherein the prologue memory hit circuitry performs a comparison of prologue bits of the received address and the stored second set of bits from the tag portion in that prologue tag memory.

2. The system of claim 1, wherein the preamble memory hit circuitry comprises:
a set of XNOR gates coupled to receive the preamble bits of the received address and the stored first set of bits from the tag portion of a corresponding way in the preamble tag memory; and
a NAND gate that receives outputs of the set of XNOR gates to output a signal indicating a hit or miss of preamble bits of that corresponding way.

3. The system of claim 1, wherein the prologue memory hit circuitry of each prologue tag memory comprises:
a set of XNOR gates coupled to receive the prologue bits of the received address and the stored second set of bits from the tag portion of a corresponding way in the prologue tag memory; and
a NAND gate that receives outputs of the set of XNOR gates to output a signal indicating a hit or miss of prologue bits of that corresponding way.

4. The system of claim 1, further comprising selection logic coupled to the one or more prologue tag memories that enables access to each of the one or more ways under control of a hit or miss signal output from the preamble memory hit circuitry of the preamble tag memory.

5. The system of claim 1, wherein the preamble tag memory further stores error correction code bits covering preamble bits of all ways in a row.

6. The system of claim 5, wherein the preamble tag memory further includes part of an error correction code circuitry.

7. The system of claim 1, wherein each prologue tag memory of the one or more prologue tag memories further stores error correction code bits.

8. The system of claim 7, wherein each prologue tag memory further includes part of an error correction code circuitry.

9. The system of claim 1, wherein each prologue tag memory of the one or more prologue tag memories is structured for storing the second set of bits and the memory data information of two or more ways.

10. The system of claim 1, wherein the memory subsystem further comprises a second preamble tag memory and one or more corresponding prologue tag memories for additional one or more ways of the memory subsystem.

11. A method of performing tag way halting, the method comprising:
receiving, at a memory subsystem, an address for lookup;
determining, using preamble memory hit circuitry of a preamble tag memory of the memory subsystem, a partial hit of the received address for a tag in a way, wherein the preamble tag memory stores a first set of bits from a tag portion of a plurality of addresses stored at the memory subsystem, wherein the preamble memory hit circuitry performs a comparison of preamble bits of the received address and the stored first set of bits from the tag portion in the preamble tag memory; and
for each partial hit of the received address, accessing a prologue tag memory of the memory subsystem associated with the way and determining, using prologue memory hit circuitry of the prologue tag memory, a hit of the received address for the tag in the way, wherein the prologue tag memory stores a second set of bits from the tag portion of at least some of the plurality of addresses stored at the memory subsystem and corresponding memory data information, wherein the prologue memory hit circuitry performs a comparison of prologue bits of the received address and the stored second set of bits from the tag portion in the prologue tag memory.

12. The method of claim 11, wherein the determining the partial hit of the received address for the tag in the way is performed in a first cycle.

13. The method of claim 12, wherein the first cycle is part of a read operation of the preamble tag memory.

14. The method of claim 12, wherein, in the first cycle, the method further comprises performing a partial error correction code operation in the preamble tag memory for the stored set of bits in a row being compared by the preamble memory hit circuitry.

15. The method of claim 12, wherein accessing the prologue tag memory associated with the way and determining the hit of the received address for the tag in the way are performed in a subsequent cycle.

16. The method of claim 15, wherein the subsequent cycle is part of a read operation of the prologue tag memory.

17. The method of claim 15, wherein, in the subsequent cycle, the method further comprises performing a partial error correction code operation in the prologue tag memory for the stored second set of bits in a row being compared by the prologue memory hit circuitry and for the memory data information in the row.

18. The method of claim 11, wherein the preamble bits of the tag portion contains between 3-7 bits.

19. The method of claim 11, wherein the preamble memory hit circuitry comprises:
a set of XNOR gates coupled to receive the preamble bits of the received address and the stored first set of bits from the tag portion of a corresponding way in the preamble tag memory; and
a NAND gate that receives outputs of the set of XNOR gates to output a signal indicating a hit or miss of preamble bits of that corresponding way.

20. The method of claim 11, wherein the prologue memory hit circuitry of each prologue tag memory comprises:
a set of XNOR gates coupled to receive the prologue bits of the received address and the stored second set of bits from the tag portion of a corresponding way in the prologue tag memory; and
a NAND gate that receives outputs of the set of XNOR gates to output a signal indicating a hit or miss of prologue bits of that corresponding way.
